(19) United States
(12) Patent Application Publication
(10) Pub. No.: US 2007/0071458 A1
(43) Pub. Date: Mar. 29, 2007

(54) Image formation device for detecting unconfirmed quality consumable cartridge and consumable cartridge thereof

(75) Inventors: Hiroshi Tanaka, Nagano-ken (JP); Hiroshi Nakazato, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/519,861

(22) Filed: Sep. 13, 2006

(30) Foreign Application Priority Data
Sep. 27, 2005 (JP) 2005-280790
Jul. 3, 2006 (JP) 2006-183153

(51) Int. Cl. G03G 15/00

(52) U.S. Cl. 399/12

(57) ABSTRACT

An image formation device for detecting an unconfirmed quality consumable cartridge, of which quality is not assured, and the consumable cartridge thereof are provided. A consumable cartridge that is replaceably attached to an image formation device, has a consumable storage section for replenishably storing a consumable, and a memory for storing operation data of the consumable such that the operation data is updated when the consumable is used. The memory can be read by the image formation device, and has a first storage area for rewritably storing an identification data of the consumable cartridge, a second storage area for rewritably storing the operation data, and a third storage area for unrewritably storing the identification data. According to this consumable cartridge, an unconfirmed quality cartridge can be detected by comparing the identification data in the first and third storage areas.

### CROSS-REFERENCE TO RELATED APPLICATIONS

This application is based upon and claims the benefit of priority from the prior Japanese Patent Applications No. 2005-280790, filed on Sep. 27, 2005, and No. 2006-183153, filed on Jul. 3, 2006, the entire contents of which are incorporated herein by reference.

### BACKGROUND OF THE INVENTION

1. Field of the Invention

The present invention relates to a consumable cartridge which can be removably attached to an image formation device, and more particularly to an image formation device for detecting an unconfirmed quality consumable cartridge, and the consumable cartridge thereof.

2. Description of the Related Art

In equipment having an image formation device, such as an electro-photographic copier, electro-photographic printer, electro-photographic facsimile, electro-photographic composite machine, inkjet printer, and inkjet composite machine, a consumable cartridge of toner or ink is removably attached, and when the consumable runs out the consumable is replenished and the cartridge is used again. It is preferable that such a consumable cartridge is a quality assured cartridge where regular toner or ink is filled. Toner and ink influence the mechanical structure, such as the cartridge and photo-sensitive drum to which toner attaches, so if toner and ink made of a material other than regular toner and ink are filled, it causes a failure of the cartridge and print engine. Therefore it has been proposed that an unconfirmed quality consumable cartridge, of which quality is not assured, is detected, and a predetermined warning is output or image formation itself is disabled. Examples are disclosed in Japanese Patent Publication No. H4-500482, Japanese Patent Application Laid-Open No. 2001-125377, and Japanese Patent Application Laid-Open No. 2000-19803.

According to these patent documents, an IC tag of a non-volatile memory is installed in a consumable cartridge, operation data, such as residual amount data and accumulated operation time data, of the consumable is stored in a memory of this IC tag, and it is checked whether this is an unconfirmed quality cartridge or not by analyzing this data.

However if a third party vendor collects the used cartridge, replenishes or refills an inappropriate consumable and copies all the data in the tag memory of the quality assured consumable cartridge to the tag memory of the replenished recycled cartridge, it is impossible to detect that the quality of the recycled cartridge is unconfirmed.

### SUMMARY

With the foregoing in view, it is an object of the present invention to provide an image formation device which can detect an unconfirmed quality consumable cartridge of which quality is not assured, and the consumable cartridge thereof.

To achieve the above object, a first aspect of the present invention is an image formation device for detecting whether a consumable cartridge that is replaceably attached is an unconfirmed quality cartridge or not, wherein the consumable cartridge has a consumable storage section for replenishably storing consumables, and a memory that can be read by the image formation device, the memory has an area where data to be updated when the consumable is used is rewritably stored in advance, an area where an identification code is unrewritably stored in advance, and an area where an identification code is rewritably stored in advance, and the image formation device further has a control unit which reads data in the memory of the consumable cartridge attached to the image formation device, compares the identification code which is rewritably stored and the identification code which is unrewritably stored, and detects that this consumable cartridge is an unconfirmed quality cartridge when the identification codes do not match.

According to the first aspect, it can be detected whether the cartridge is an unconfirmed quality consumable cartridge or not, by comparing the identification code which is rewritably stored and the identification code which is unrewritably stored.

According to a preferred mode of the first aspect, the identification code which is rewritably stored and the identification code which is unrewritably stored in the memory are the same.

According to another preferred mode of the first aspect, the identification code stored in the memory is an identification code for identifying the consumable cartridge or an identification code for identifying the memory itself. Either one of these identification codes can be used.

According to another preferred mode of the first aspect, the memory further has an area where an error detection code, generated by the identification code and the operation data, for detecting an error of the operation data is rewritably stored in advance, and when the identification code which is rewritably stored and the identification code which is unrewritably stored match, the control unit generates an error detection code from the identification code and the operation data, and compares the generated error detection code and the error detection code which is rewritably stored in the memory to detect that the data which is rewritably stored in the memory has an error.

In the above preferred modes, the memory further has an area where an unconfirmed quality detection code, which is generated by encoding the error detection code rewritably stored in the memory, is rewritably stored in advance, and when an error is detected in the operation data based on the error detection code, the control unit generates an unconfirmed quality detection code by encoding the error detection code which is rewritably stored in the memory, and compares the generated unconfirmed quality detection code and the unconfirmed quality detection code stored in the memory to detect whether the cartridge is an unconfirmed quality consumable cartridge. By using the error detection code and the unconfirmed quality detection code, an error of the operation data and unconfirmed quality consumable cartridge can be separately detected.

To achieve the above object, a second aspect of the present invention is an image formation device for detecting whether a consumable cartridge that is replaceably attached is an unconfirmed quality cartridge or not, wherein the consumable cartridge has a consumable storage section for replenishably storing consumables, and a memory that can be read by the image formation device, the memory further has a first area where a first identification code for identifying a previously added consumable cartridge is unrewritably stored when the consumable is replenished and reused, a second area where a second identification code for identifying a presently added consumable cartridge is unrewritably stored when the consumable is replenished and reused, and a third area where an unconfirmed quality detection code, which is generated by encoding the first identification code stored in the first area, is rewritably stored, and the image formation device further has a control unit which reads the data in the memory of the consumable cartridge attached in the image formation device, generates an unconfirmed quality detection code by encoding the first identification code stored in the first area, and compares the generated unconfirmed quality detection code and the unconfirmed quality detection code stored in the memory to detect an unconfirmed quality consumable cartridge.

According to the second aspect, every time the consumable is replenished and reused, the identification code after reuse is unrewritably added to the memory, and an unconfirmed quality detection code generated by encoding the first identification code is rewritably added, so an unconfirmed quality consumable cartridge can be detected using this unconfirmed quality detection code.

Even if the third party vendor copies all or a part of the data in the tag memory of a quality assured product to the tag memory of a collected product, unconfirmed quality can be detected.

### BRIEF DESCRIPTION OF THE DRAWINGS

FIG. 1 is a perspective view depicting the image formation device according to the present embodiment;

FIG. 2 is a side view depicting the image formation device viewed in the X direction in FIG. 1;

FIG. 3 is a diagram depicting a configuration of the control unit and a part of the print engine according to the present embodiment;

FIG. 4 shows data in the tag memories of a conventional collected toner cartridge and recycled toner cartridge by a regular vendor;

FIG. 5 shows data in the tag memories of a conventional collected toner cartridge and recycled toner cartridge by a third party vendor;

FIG. 6 shows data in the tag memories of the collected toner cartridge and recycled toner cartridge by a regular vendor according to the first embodiment;

FIG. 7 shows data in the tag memories of the collected toner cartridge and recycled toner cartridge by a third party vendor according to the first embodiment;

FIG. 8 is a flow chart depicting the unconfirmed quality toner cartridge detection processing by the control unit according to the first embodiment;

FIG. 9 shows data in the tag memories of the collected toner cartridge and recycled toner cartridge by a regular vendor according to the second embodiment;

FIG. 10 shows data in the tag memories of the collected toner cartridge and recycled toner cartridge by a third party vendor according to the second embodiment;

FIG. 11 is a flow chart depicting the unconfirmed quality toner cartridge detection processing by the control unit according to the second embodiment;

FIG. 12 shows data in the tag memories of the collected toner cartridge and recycled toner cartridge by a regular vendor according to the third embodiment;

FIG. 13 shows data in the tag memories of the collected toner cartridge and recycled toner cartridge by a third party vendor according to the third embodiment;

FIG. 14 shows data in the tag memories of the collected toner cartridge and recycled toner cartridge by a third party vendor according to the third embodiment; and

FIG. 15 is a flow chart depicting the unconfirmed quality toner cartridge detection processing by the control unit according to the third embodiment.

### DESCRIPTION OF THE PREFERRED EMBODIMENTS

Embodiments of the present invention will now be described with reference to the drawings. The technical scope of the present invention, however, is not limited to these embodiments, but reaches the content of the claims and equivalents thereof.

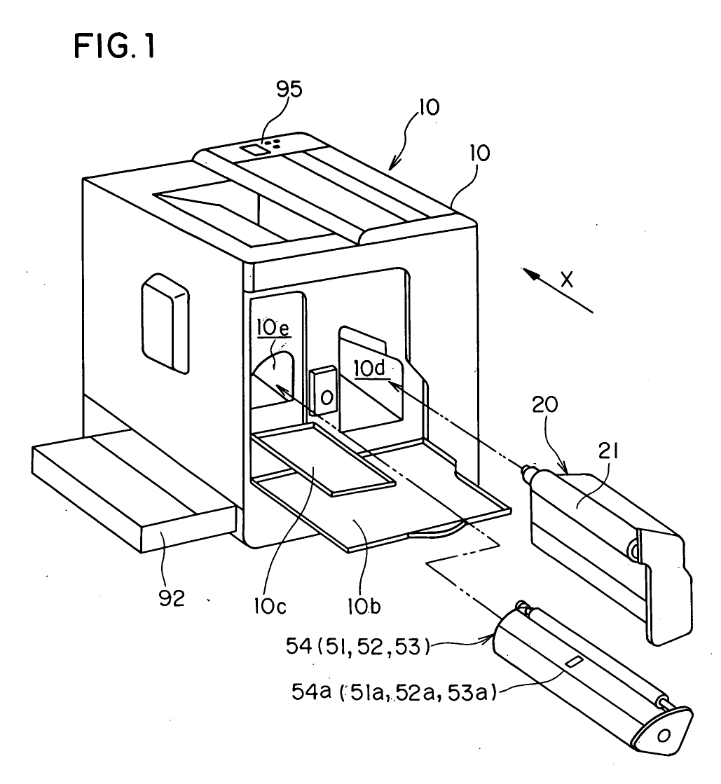

FIG. 1 is a perspective view depicting the image formation device according to the present embodiment. In the image formation device 10, that is a printer, for example, a display operation panel 95 is provided on a surface of the main body 10a, a paper feed cartridge 92 is provided on a side face, open/close covers 10b and 10c are provided on another side face, a photosensitive unit 20 is attached/removed through the opening 10d which can be seen when the open/close cover 10b is opened, and toner cartridges 51-54 which are development units are attached/removed through the opening 10e which can be seen when the open/close cover 10c is opened. The toner cartridges 51-54 are consumable cartridges for containing toner, which is consumable, where the tag memories 51a-54a for storing operation data, such as the residual amount of toner and the operation time of the cartridge, are provided.

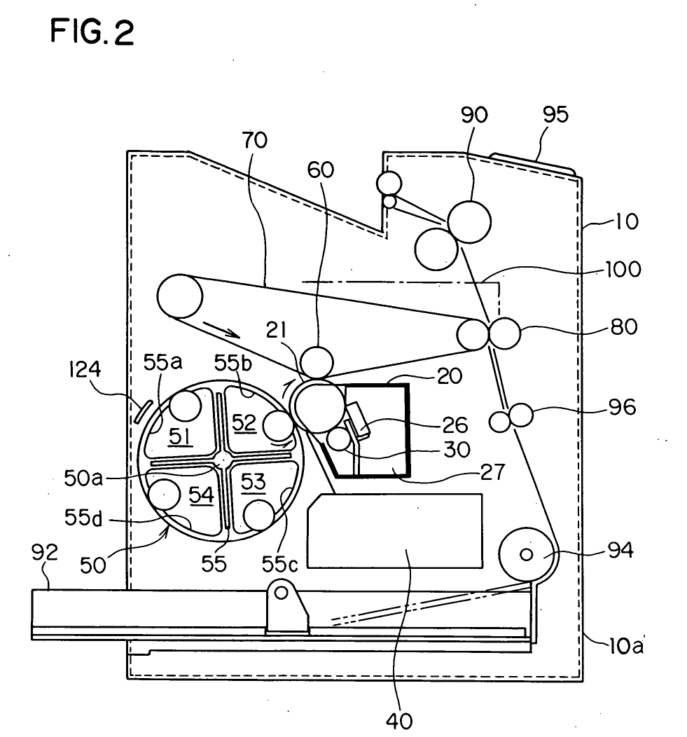

FIG. 2 is a side view depicting the image formation device viewed from the X direction in FIG. 1. In the main body 10a, the photosensitive unit 20 having a photosensitive drum 21, a charge unit 30 for charging the photosensitive body, a cleaning blade 26 for toner, and a housing unit 27 for consumed toner, an exposure unit 40 for forming a latent image by irradiating laser onto the photosensitive drum 21, a development unit 50 for supplying cyan, magenta, yellow and black toner onto the latent image on the photosensitive drum 21 to develop the image, a primary transfer unit 60 for transferring the toner image developed on the photosensitive drum 21 to an intermediate transfer medium 70, a secondary transfer unit 80 for transferring the toner image on the intermediate transfer medium 70 to print paper, paper feed rollers 94 and 96 and a control unit 100 are housed.

In the development unit 50, toner cartridges 51-54 containing the above mentioned four colors of toner are removably attached to a development rotary 55, and toner is supplied from each toner cartridge to the photosensitive drum 21 by rotating the development rotary 55 around the center 50a. Each toner cartridge 51-54 is attached to the attachment sections 55a, 55b, 55c and 55d of the development unit 50. And a memory access unit 124 is installed near the development unit 50, and performs the read and write access operation to the tag memories 51a-54a of each toner cartridge 51-54.

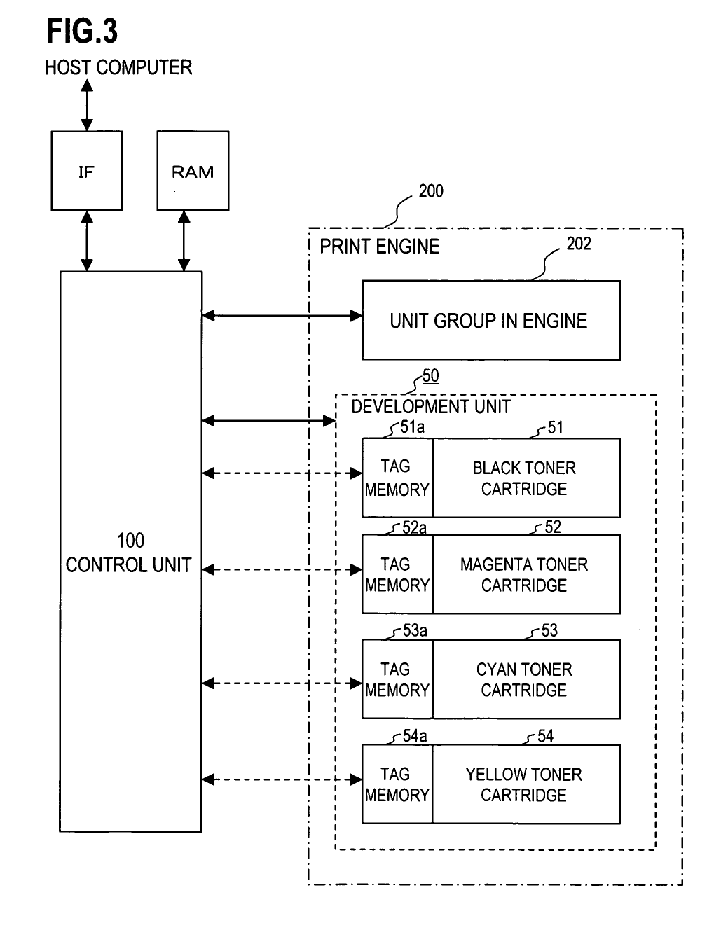

FIG. 3 is a diagram depicting a configuration of the control unit and a part of the print engine of the present embodiment. The control unit 100 receives print data from the host computer, scanner unit or fax unit via the interface IF, and performs predetermined image processing. Also the control unit 100 supplies the processed image formation data to the print engine 200, and controls image formation corresponding to the print data by controlling the unit group 202 and development unit 50 in the print engine 20.

Each toner cartridge 51-54 to be attached to the development unit 50 has a storing section for replenishably storing toner, which is consumable, and has tag memories 51a-54a for storing management information on the residual amount of toner and the accumulated operation time of the cartridge. The control unit 100 reads data from the tag memory, performs print control corresponding to the management information, and updates the management information on the residual amount of toner and accumulated operation time of the cartridge to the latest information after printing. The control unit 100 also reads data from the tag memory, checks whether the toner cartridge is a regular product (quality assured product) or an unconfirmed quality product, and outputs a warning on the operation display panel 95 if necessary, or disables the print operation in a worse case scenario.

Now a method of detecting an unconfirmed quality toner cartridge by the control unit 100 will be described.

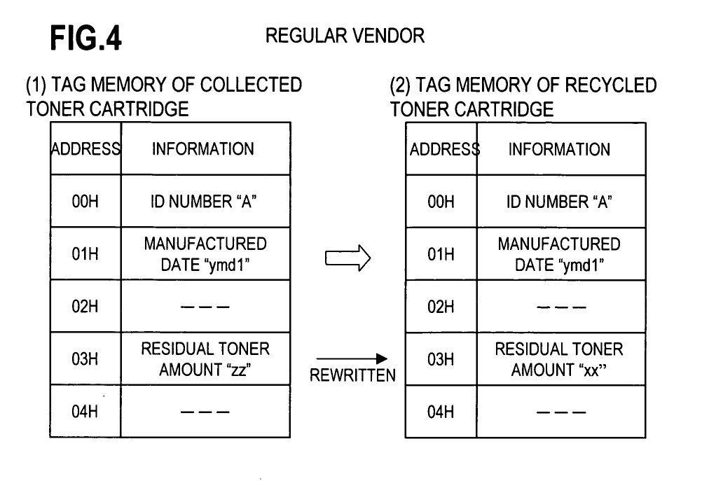

FIG. 4 shows conventional data in the tag memories of a collected toner cartridge and a recycled cartridge by a regular vendor. Here it is assumed that the tag memory is constructed such that data can be read or written in the storage area unit, which has 16 addresses as one set. It is also assumed that the tag memory is a non-volatile memory, such as a flash memory or ferroelectric memory, where the storage area in which data is written can be changed to a write protected state so that the data can no longer be rewritten, that is unrewritable.

In the tag memory shown in FIG. 4, the identification data of the toner cartridge is stored in the storage area at address 00H (H is hexadecimal), the manufactured date data of the toner cartridge is stored in the storage area at address 01H, operation data, such as the residual amount of toner and accumulated operation time of the cartridge, is stored in the storage area at address 03H, and various other data is stored in other storage areas in addresses 02H and 04H.

In the tag memory of the collected toner cartridge in FIG. 4 (1), the residual toner amount data, which has no residual amount, and the accumulated operation time exceeding the operable time, are stored. So a regular vendor replenishes toner in the storage section, writes the new residual toner amount data and accumulated operation time data in the storage area at address 03H of the tag memory, and distributes it as a recycled toner cartridge in (2) to market.

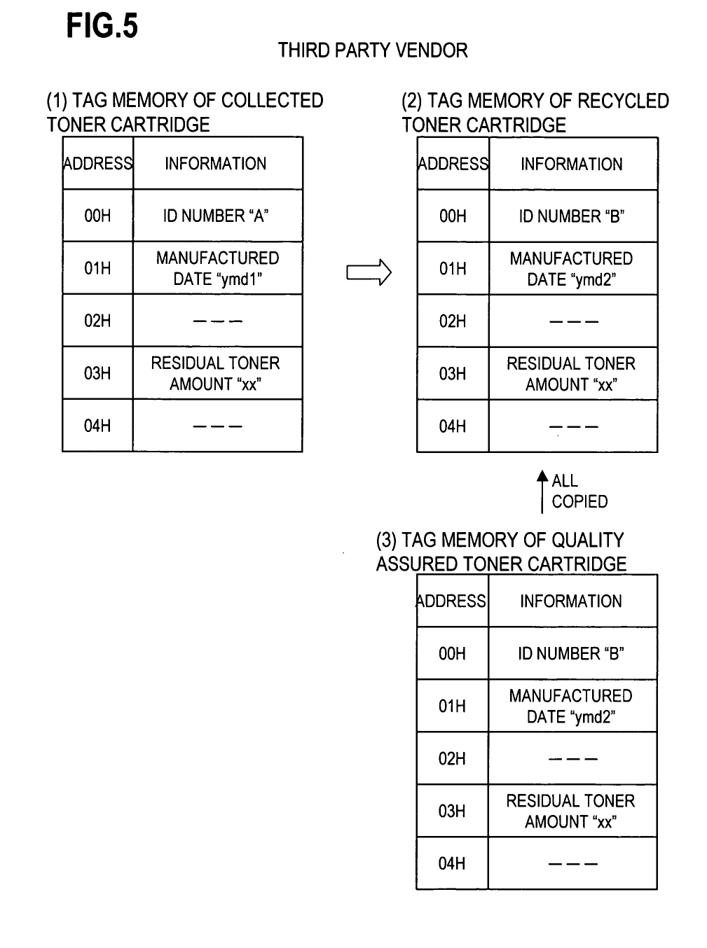

FIG. 5 shows conventional data in the tag memory of the collected toner cartridge and recycled toner cartridge by a third party vendor. A third party vendor normally does not know the structure of the tag memory and stored data, so they cannot rewrite only residual toner amount data in the storage area at address 03H, unlike a regular vendor. Therefore, as shown in FIG. 5 (3), a third party vendor attempts to copy all data stored in the tag memory of the quality assured toner cartridge to the tag memory of the collected toner cartridge in (1), and distributes the cartridge in FIG. 5 (2) to market as a recycled toner cartridge. In the tag memory of the collected toner cartridge in FIG. 5 (1), the identification data is “A”, but in the tag memory of the recycled toner cartridge in FIG. 5 (2), the identification data is rewritten to “B”, which is the same as a quality assured product of FIG. 5 (3), and the residual toner amount is also rewritten to “XX”, which is the replenished amount.

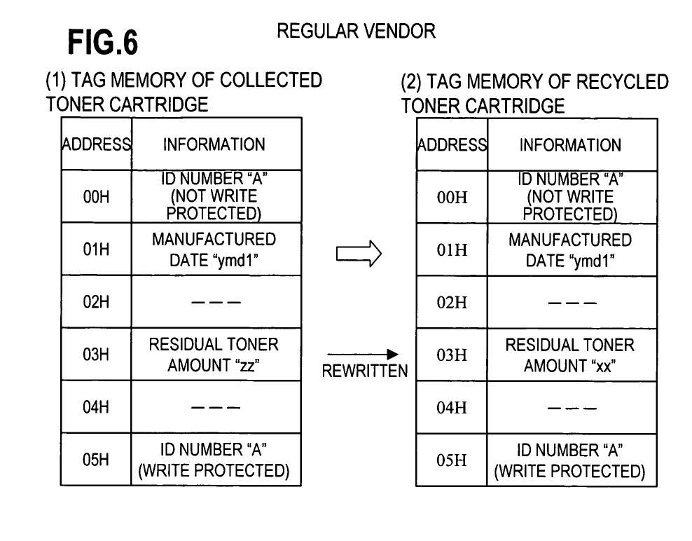

FIG. 6 shows data in the tag memories of the collected toner cartridge and recycled toner cartridge by a regular vendor according to the first embodiment. In the tag memory of the first embodiment, the identification data “A” of the cartridge is written with write protection (unrewritably) in the storage area at address 05H, in addition to the storage data in FIG. 4. The identification data in the storage area at address 00H, on the other hand is not write protected (rewritable). In the write protected storage area, a memory writer available to general users cannot clear the write protection. Therefore the data in the write protected storage area can be read but not rewritten.

A regular vendor who knows the data structure in the tag memory rewrites the area at address 03H of the tag memory of the collected toner cartridge (1) to update operation data, such as the residual toner amount after replenishment, just like FIG. 4, and distributes it to market as a recycled toner cartridge in (2).

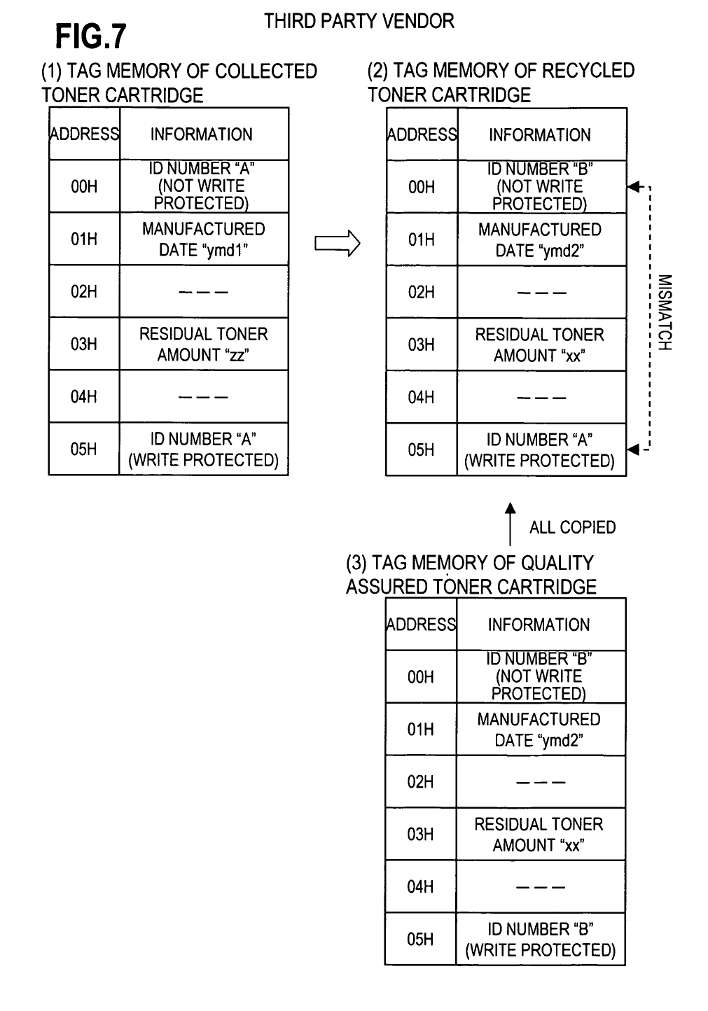

FIG. 7 shows data in the tag memories of a collected toner cartridge and recycled toner cartridge by a third party vendor according to the first embodiment. Just like FIG. 5, when the third party vendor copies all the data in the tag memory of the quality assured toner cartridge in FIG. 5 (3) to the tag memory of the collected toner cartridge in (1), the data of the quality assured product is copied in the tag memory of the recycled toner cartridge in (2), except for the write protected storage area at address 05H. Therefore in the tag memory of the recycled toner cartridge distributed by the third party vendor to market, the identification data “B” in the storage area at address 00H and the identification data “A” in the storage area at address 05H do not match. Therefore by comparing the identification data of these storage areas, a recycled toner cartridge with unconfirmed quality can be detected.

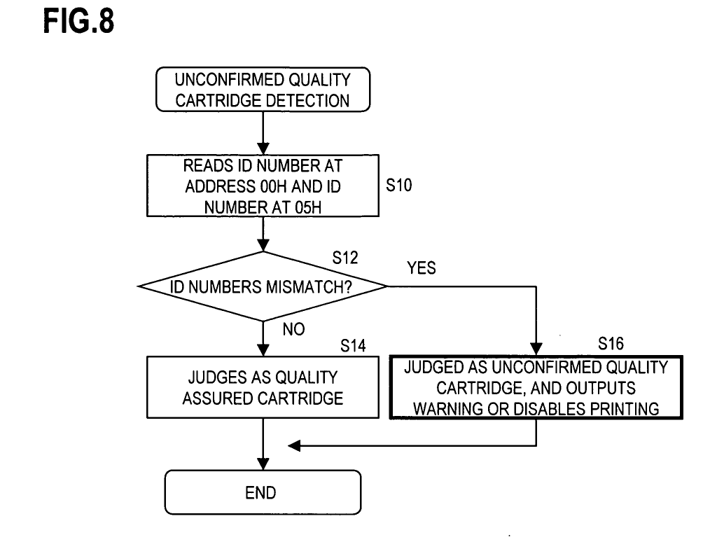

FIG. 8 is a flow chart depicting the unconfirmed quality toner cartridge detection processing by the control unit according to the first embodiment. The control unit 100 shown in FIG. 3 accesses the tag memory of the attached toner cartridge, and reads the identification data in the storage areas at addresses 00H and 05H (S10). And it is checked whether both identification data match by comparison (S12). If there is a match, this toner cartridge is judged as a quality assured cartridge, as shown in FIG. 6 (S14), if there is a mismatch, this toner cartridge is judged as an unconfirmed quality cartridge as shown in FIG. 7 (S16), and a warning is output or printing is disabled if necessary. By storing the identification data of the cartridge in a rewriteable storage area (address 00H), which is not write protected and in an unrewritable storage area (address 05H) which is write protected in the tag memory, an unconfirmed quality cartridge can be detected if a third party vendor copied all the information in the tag memory of the quality assured cartridge illegally.

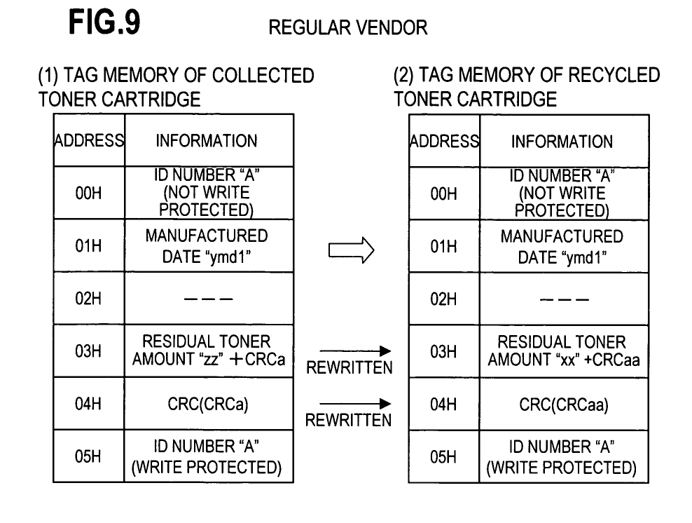

FIG. 9 shows the data in the tag memories of the collected toner cartridge and recycled toner cartridge by a regular vendor according to the second embodiment. In the first embodiment, if a third party vendor knows how to set a cartridge to be a regular recycled cartridge by updating the operation data, such as the residual toner mount, in the storage area at address 03H in the tag memory by some means, an unconfirmed quality cartridge can no longer be detected even if an identification card is stored in an unrewritable storage area.

Therefore in the second embodiment, as FIG. 9 (1) shows, a first error detection code CRCa generated by the identification data in the storage area at address 00H and the operation data “zz”, such as the residual toner amount, is stored in the storage area at address 03H in addition to the operation data “zz”. Also a second error detection code CRC (CRCa) generated by operation from this error detection code CRCa is stored in the storage area at address 04H.

The first error detection code CRCa is a code for detecting an error of the operation data, such as the residual toner amount, and need not be an error correction code (ECC). However it is preferable that an error can be detected and corrected. Therefore in the present embodiment, a CRC (Cyclic Redundancy Check) code is used as the first error detection code. Using a CRC code improves the error detection capability. The second error detection code CRC (CRCa) can simply be a code encoded the first error detection code CRCa by an encryption operation. In this example, the second code is generated by an encoding circuit for generating CRC code.

A regular vendor replenishes toner to the collected toner cartridge, writes the new operation data, such as the residual toner amount and the first error detection code CRCaa, to the storage area at address 03H of the tag memory, and also writes the second error detection code CRC (CRCaa), which is the code encoded first error detection code CRCaa, to the storage area at address 04H.

The control unit of the image formation device reads the data in the tag memory when power is ON, for example, generates the first error detection code from the identification data in the storage area at address 00H and operation data, such as the residual toner amount, in the storage area at address 03H, compares it with the first error detection code CRCaa in the storage area at address 03H, and confirms that the operation data has no error. If there is an error, the operation data is corrected and rewritten. The control unit checks whether this is a quality assured product or not by the first error detection code CRCaa in the storage area at address 03H and the second error detection code CRC (CRCaa) in the storage area at address 04H.

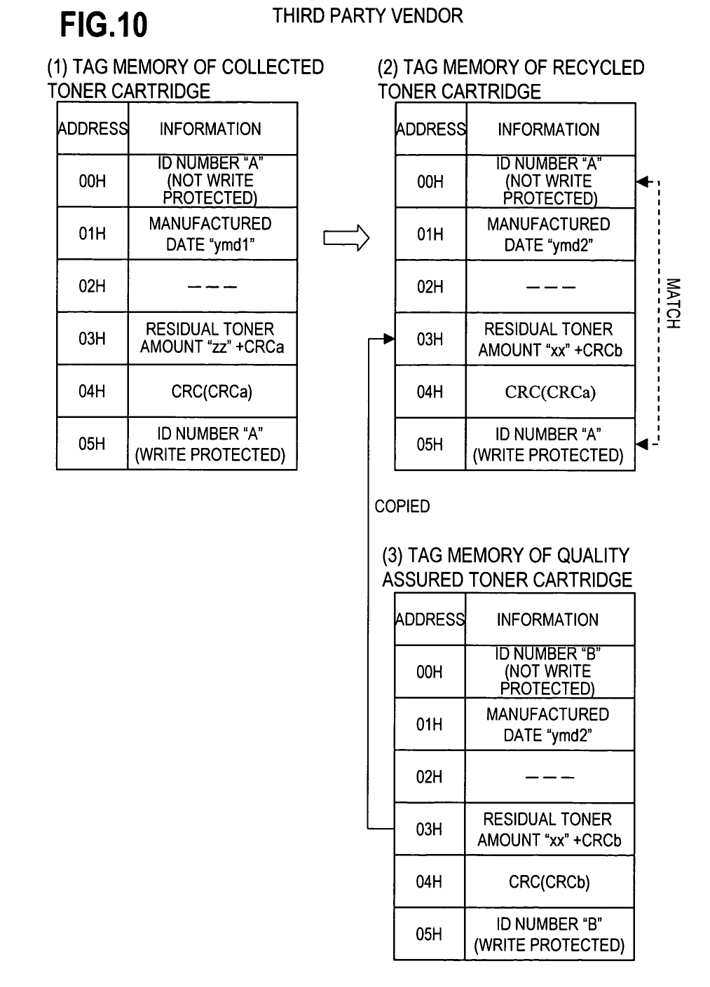

FIG. 10 shows the data in the tag memories of the collected toner cartridge and recycled toner cartridge by a third party vendor according to the second embodiment. The third party vendor attempts not to copy all the data in the tag memory of the quality assured toner cartridge in FIG. 10 (3), but to write only the operation data, such as the residual toner amount, in the storage area at address 03H to the tag memory of the collected toner cartridge. As a result, an unconfirmed quality cartridge cannot be detected merely by comparing the identification data in the storage area at addresses 00H and 05H, which was effective in the first embodiment.

However whether the operation data, such as the residual toner amount, has an error or not, and whether this is an unconfirmed quality cartridge or not can be detected by the first error detection code CRCb at address 03H and the second error detection code at address 04H.

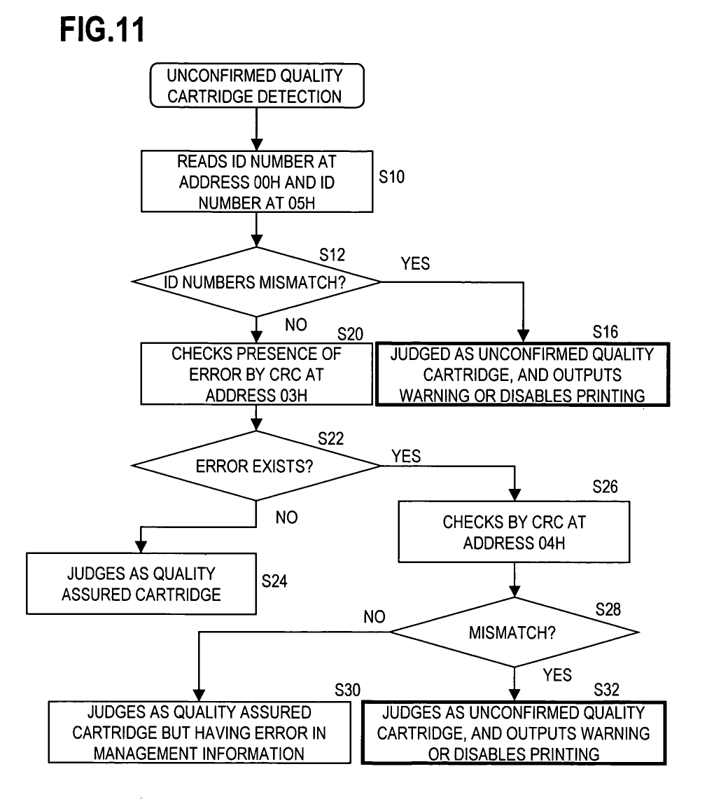

FIG. 11 is a flow chart depicting the unconfirmed quality toner cartridge detection processing by the control unit according to the second embodiment. In FIG. 11, steps S10, S12 and S16 are the same as FIG. 8. If a third party vendor copies all the data of the tag memory of the quality assured cartridge, an unconfirmed quality cartridge can be detected by the method of the first embodiment (S16). If identification data matches, the control unit 100 checks whether an error exist or not by the first error detection code CRC at address 03H in the second embodiment (S20). Specifically, the control unit 100 generates an error detection code from the identification code at address 00H and operation data, such as the residual toner amount, at address 03H, compares it with the first error detection code at address 03H, and detects an error if there is a mismatch.

If an error is not detected by the first error detection code (NO in S22), this cartridge can be judged as a quality assured cartridge (S24). If an error is detected (YES in S22), it is possible either that the operation data, such as the residual toner amount, has an error, or this cartridge is an unconfirmed quality cartridge. Therefore the control unit checks these two possibilities by the second error detection code (encoded data) at address 04H (S26). Specifically, the control unit generates an error detection code from the first error detection code at address 03H, and checks whether this matches with the second error detection code at address 04H. If there is a match (NO in S28), the control unit judges that this cartridge is a quality assured cartridge and the operation data has an error (S30). If there is a mismatch (YES in S28), the control unit judges that this cartridge is an unconfirmed quality cartridge, and outputs a warning or disables printing if necessary (S32).

In the second embodiment, an unconfirmed quality cartridge can be detected even if a third party vendor overwrites only the operation data in the tag memory.

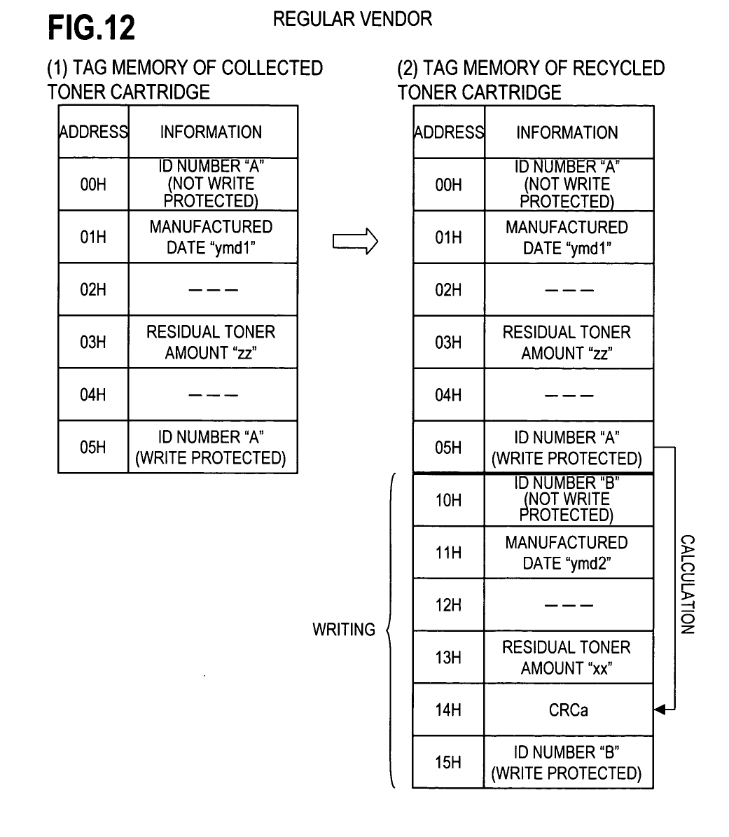

FIG. 12 shows the data in the tag memories of the collected toner cartridge and recycled toner cartridge by a regular vendor according to the third embodiment. In the third embodiment, the regular vendor writes the data in a new storage area of the tag memory of the collected cartridge, and distributes it as a recycled cartridge. In other words, in the tag memory of the collected cartridge in FIG. 12 (1), the data shown in the first group storage area at addresses 00H-05H is stored, just like the first embodiment. And after the toner is replenished, the same data as the first group is written to the second group storage area at addresses 10H-15H in the tag memory of the recycled cartridge in FIG. 12 (2). And in the storage area at address 14H in the second group storage area, an error correction code (unconfirmed quality detection code) CRCa generated by encoding the identification data at address 05H in the first group storage area is written. This error correction code can be one generated by performing a predetermined encoding on the identification data, and need not be an error correction code.

When this cartridge is recycled and used again, the regular vendor writes the same data in the third group storage area, and writes the unconfirmed quality detection code there.

And the control unit confirms that the cartridge is a quality assured product by the unconfirmed quality detection code at address 14H in the tag memory.

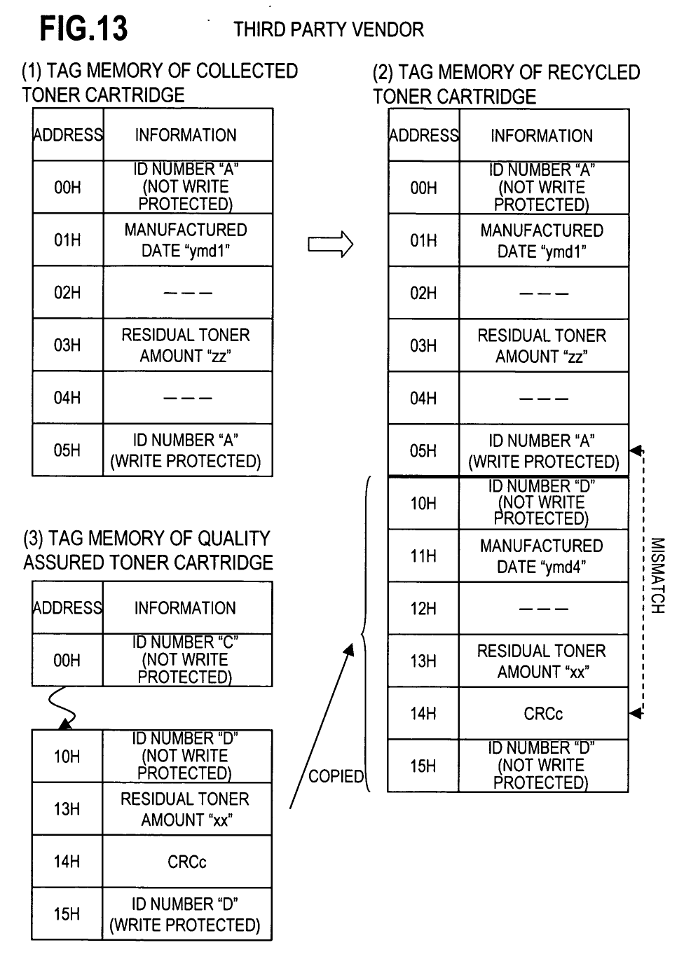

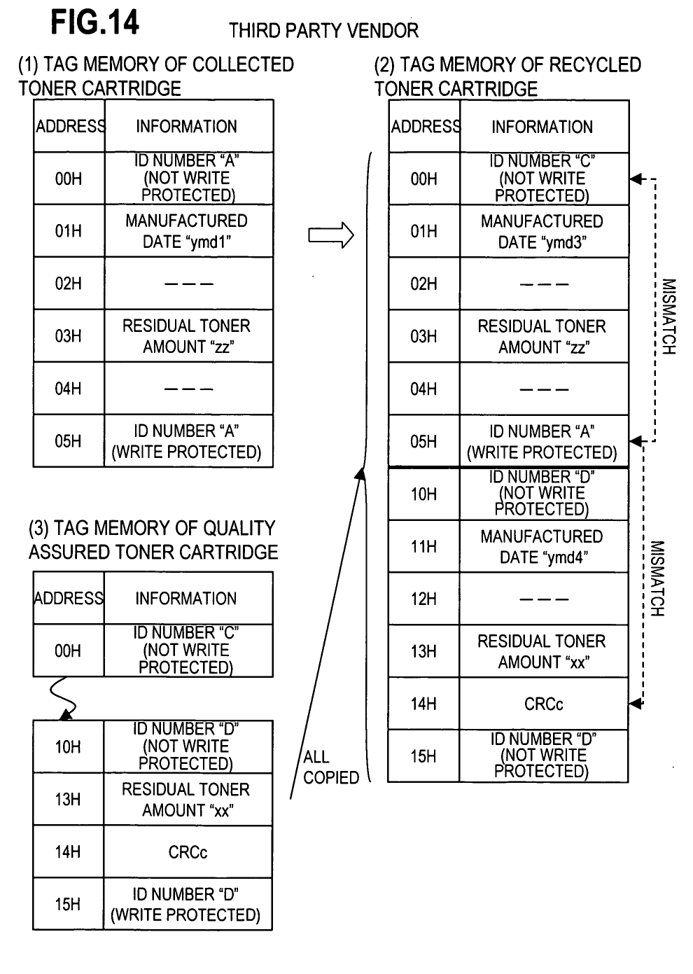

FIG. 13 and FIG. 14 show data in the tag memories of the collected toner cartridge and recycled toner cartridge by a third party vendor according to the third embodiment. The example in FIG. 13 shows the case when the third party vendor copies the data in the second group storage area (addresses 10H-15H) of the tag memory of the quality assured product in (3) to the tag memory of the collected toner cartridge in (1). In this case, in the tag memory of the recycled cartridge in (2), the unconfirmed quality detection code CRCc corresponding to the identification data “C” in the tag memory of the quality assured product is written at address 14H, which does not match the unconfirmed quality detection code generated by the identification data “A” at address 05H, so it can be detected that this cartridge is an unconfirmed quality cartridge. In this case, the identification data at addresses 00H and 05H of the data in the first group storage area (addresses 00H-05H) match, so unconfirmed quality cannot be detected by this comparison.

The example in FIG. 14 is a case when the third party vendor copies all the data, including the first group (addresses 00H-05H) and the second group (addresses 10H-15H) in the tag memory of the quality assured product in FIG. 14 (3) to the tag memory of the collected toner cartridge in (1), and distributes it to market as the recycled cartridge in (2). In this case, the identification data at address 05H, which is write protected, is still the original identification data “A”, so it can be detected that the cartridge is of unconfirmed quality by the unconfirmed quality detection code CRCc at address 14H. And in this case, unconfirmed quality can also be detected by comparing the identification data at addresses 00H and 05H of the data in the first group storage area (addresses 00H-05H), which is a mismatch.

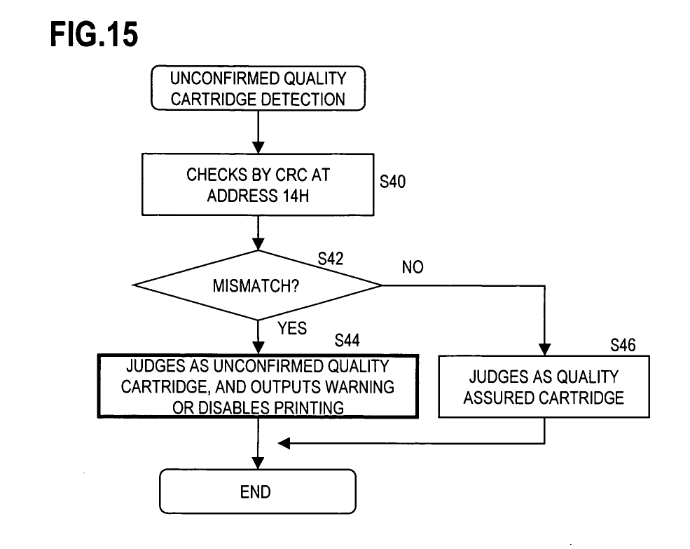

FIG. 15 is a flow chart depicting the unconfirmed quality toner cartridge detection processing by the control unit according to the third embodiment. The control unit 100 in FIG. 3 checks whether this is an unconfirmed quality cartridge or not by using the unconfirmed quality detection code at address 14H in the second group storage area of the tag memory (S40). Specifically, the control unit 100 generates a detection code by encoding the identification code at address 05H in the first group storage area, and compares it with the unconfirmed quality detection code at address 14H. If there is a match, the cartridge is judged as a quality assured cartridge (S46), and if a mismatch, the cartridge is judged as an unconfirmed quality cartridge (S44).

As the above flow chart shows, the identification code at address 00H in the first group storage area is not absolutely required in the third embodiment. All that is required is that the write protected identification code at address 05H is written.

Although this is not shown in FIG. 15 unconfirmed quality cartridge detection in FIG. 14 is also possible according to the method of the first embodiment in FIG. 8. In this case, the identification code at address 00H in the first group storage area is required.

As described above, according to the present embodiment, even if a third party vendor copies all or part of the data in the tag memory of the quality assured product to the tag memory of the collected cartridge, this can be detected. By detecting the unconfirmed quality cartridge, problems in the print engine caused by an inappropriate consumable can be warned in advance, and printing can be disabled in the worse case scenario.

The identification code according to the above embodiment can simply be a code for identifying a consumable cartridge, including a unique code assigned to each consumable cartridge, and a unique code for identifying the tag memory itself, which is assigned to each tag memory, for example.

What is claimed is:

1. An image formation device for detecting whether a consumable cartridge, that is replaceably attached, is an unconfirmed quality cartridge or not, wherein
the consumable cartridge comprises a consumable storage section for replenishably storing consumables and a memory that can be read by the image formation device,
the memory comprises an area where operation data to be updated when the consumable is used is rewritably stored in advance, an area where an identification code is unrewritably stored in advance, and an area where an identification code is rewritably stored in advance,
the image formation device comprising:
a control unit which reads data in the memory of the consumable cartridge attached to the image formation device, compares the identification code which is rewritably stored and the identification code which is unrewritably stored, and detects that the consumable cartridge is an unconfirmed quality consumable cartridge when the identification codes do not match.

2. The image formation device according to claim 1, wherein the identification code which is rewritably stored and the identification code which is unrewritably stored in the memory are the same.

3. The image formation device according to claim 1, wherein the identification code stored in the memory is an identification code for identifying the consumable cartridge or an identification code for identifying the memory itself.

4. The image formation device according to claim 1, wherein
the memory further comprises an area where an error detection code, generated by the identification code and the operation data, for detecting an error of the operation data is rewritably stored in advance, and
the control unit, when the identification code which is rewritably stored and the identification code which is unrewritably stored match, generates an error detection code from the identification code and the operation data, and compares the generated error detection code with the error detection code which is rewritably stored in the memory to detect that the operation data which is rewritably stored in the memory has an error.

5. The image formation device according to claim 4, wherein
the memory further comprises an area where an unconfirmed quality detection code, which is generated by encoding the error detection code rewritably stored in the memory, is rewritably stored in advance, and
the control unit, when an error is detected in the operation data based on the error detection code, generates an unconfirmed quality detection code by encoding the error detection code which is rewritably stored in the memory, and compares the generated unconfirmed quality detection code with the unconfirmed quality detection code stored in the memory to detect whether the cartridge is an unconfirmed quality consumable cartridge.

6. A consumable cartridge that is replaceably attached to an image formation device, comprising:
a consumable storage section for replenishably storing consumables; and
a memory that can be read by the image formation device, wherein
the memory comprises an area where data to be updated when the consumables are used is rewritably stored, an area where an identification code is rewritably stored, and an area where an identification code is unrewritably stored.

7. The consumable cartridge according to claim 6, wherein the identification code stored in the memory is an identification code for identifying the consumable cartridge or an identification code for identifying the memory itself.

8. The consumable cartridge according to claim 6, wherein the memory further comprises an area where an error detection code, generated by the identification code and the operation data, for detecting an error of the operation data is rewritably stored.

9. The consumable cartridge according to claim 8, wherein the memory further comprises an area where an unconfirmed quality detection code, which is generated by encoding the error detection code stored in the memory, is rewritably stored.

10. A method of detecting an unconfirmed quality cartridge for detecting whether a consumable cartridge that is replaceably attached to an image formation device is an unconfirmed quality consumable cartridge or not, using a control unit of the image formation device, wherein the consumable cartridge comprises a consumable storage section for replenishably storing consumables and a memory that can be read by the image formation device, and the memory comprises an area where data to be updated when the consumables are used is rewritably stored in advance, an area where an identification code is unrewritably stored in advance, and an area where an identification codes is rewritably stored in advance,
the method comprising the steps of:
reading data in the memory installed in the consumable cartridge attached to the image formation device;
comparing the identification code which is rewritably stored with the identification code which is unrewritably stored in the memory; and
detecting that the consumable cartridge is an unconfirmed quality consumable cartridge when the identification codes do not match in the comparison step.

11. The method of detecting an unconfirmed quality consumable cartridge according to claim 10, wherein the identification code stored in the memory is an identification code for identifying the consumable cartridge or an identification code for identifying the memory itself.

12. The method of detecting an unconfirmed quality consumable cartridge according to claim 10, wherein the memory further comprises an area where an error detection code, generated by the identification code and the operation data, for detecting an error of the operation data is rewritably stored in advance,
further comprising, when the rewritably stored identification code and unrewritably stored identification code match in the comparison step, the steps of:
generating an error detection code from the identification code which is stored in the memory and rewritably stored operation data;
comparing the generated error detection code with the error detection code which is rewritably stored in the memory; and
detecting that the operation data which is rewritably stored in the memory has an-error based on the comparison result.

13. The method of detecting an unconfirmed quality consumable cartridge according to claim 12, wherein the memory further comprises an area where an unconfirmed quality detection code, which is generated by encoding the error detection code rewritably stored in the memory, is rewritably stored in advance,
further comprising, when an error is detected in the operation data based on the error detection code, the steps of:
encoding the error detection code to generate an unconfirmed quality detection code;
comparing the generated unconfirmed quality detection code with the unconfirmed quality detection code stored in the memory; and
detecting whether the cartridge is an unconfirmed quality consumable cartridge or not based on the comparison result.

14. An image formation device for detecting whether a consumable cartridge that is replaceably attached is an unconfirmed quality cartridge or not, wherein
the consumable cartridge comprises a consumable storage section for replenishably storing consumables and a memory that can be read by the image formation device,
the memory at least comprises a first area where a first identification code for identifying a previously added consumable cartridge is unrewritably stored when the consumable is replenished and reused, a second area where a second identification code for identifying a presently added consumable cartridge is unrewritably stored when the consumable is replenished and reused, and a third area where an unconfirmed quality detection code, which is generated by encoding the first identification code stored in the first area, is rewritably stored,
the image formation device comprising:
a control unit which reads the data in the memory of the consumable cartridge attached in the image formation device, generates at least an unconfirmed quality detection code by encoding the first identification code stored in the first area, and comparing the generated unconfirmed quality detection code with the unconfirmed quality detection code stored in the memory to detect an unconfirmed quality consumable cartridge.

15. A consumable cartridge that is replaceably attached to an image formation device, comprising:
a consumable storage section for replenishably storing consumables; and
a memory that can be read by the image formation device, wherein
the memory further comprises a first area where a first identification code for identifying a previously added consumable cartridge is unrewritably stored when the consumable is replenished and reused, a second area where a second identification code for identifying a presently added consumable cartridge is unrewritably stored when the consumable is replenished and reused, and a third area where an unconfirmed quality detection code generated by encoding the first identification code stored in the first area is rewritably stored.

16. An unconfirmed quality consumable cartridge detection method for detecting whether a consumable cartridge that is replaceably attached to an image formation device is an unconfirmed quality consumable cartridge or not, using a control unit of the image formation device, wherein the consumable cartridge comprises a consumable storage section for replenishably storing consumables and a memory that can be read by the image formation device, and the memory comprises a first area where a first identification code for identifying a previously added consumable cartridge is unrewritably stored when the consumable is replenished and reused, a second area where a second identification code for identifying a presently added consumable cartridge is unrewritably stored when the consumable is replenished and reused, and a third area where an unconfirmed quality detection code generated by encoding the first identification code stored in the first area is rewritably stored,
the method comprising the steps of:
reading data in the memory installed in the consumable cartridge attached to the image formation device;
generating an unconfirmed quality detection code by encoding the first identification code unrewritably stored in the memory;
comparing the generated unconfirmed quality detection code with the unconfirmed quality detection code stored in the memory; and
detecting whether the consumable cartridge is an unconfirmed quality cartridge or not based on the comparison result.
